(19) United States
(12) Patent Application Publication
(10) Pub. No.: US 2010/0253801 A1
(43) Pub. Date: Oct. 7, 2010

(54) IMAGE RECORDING APPARATUS AND DIGITAL CAMERA

(75) Inventor: Tetsuya KONISHI, Machida-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/751,233

(22) Filed: Mar. 31, 2010

(30) Foreign Application Priority Data
Apr. 1, 2009 (JP) 2009-089020

(51) Int. Cl. H04N 5/14

(52) U.S. Cl. 348/222.1; 348/700; 348/E05.062

(57) ABSTRACT

The image recording apparatus includes: an information acquisition unit; a metadata generation unit that generates metadata based upon acquired information, the metadata being different from an image to be recorded and the acquired information being obtained by the information acquisition unit at least after the image is obtained; and an information recording unit that records the metadata having been generated and the image in correlation to each other.

### INCORPORATION BY REFERENCE

The disclosure of the following priority application is herein incorporated by reference:

Japanese Patent Application No. 2009-089020 filed Apr. 1, 2009

### BACKGROUND OF THE INVENTION

1. Field of the Invention

The present invention relates to an image recording apparatus and a digital camera.

2. Description of Related Art Japanese Laid Open Patent Publication No. 2007-52626 discloses a technology whereby a person, an object or the like in a movie image is identified through image recognition and metadata are generated by converting the recognition results to text data.

### SUMMARY OF THE INVENTION

The technology in the related art allows information acquired from the movie image to be appended as metadata. In other words, it is difficult to append information that cannot be acquired from the movie image.

According to the 1st aspect of the present invention, an image recording apparatus comprises: an information acquisition unit; a metadata generation unit that generates metadata based upon acquired information, the metadata being different from an image to be recorded and the acquired information being obtained by the information acquisition unit at least after the image is obtained; and an information recording unit that records the metadata having been generated and the image in correlation to each other.

According to the 2nd aspect of the present invention, it is preferred that in the image recording apparatus according to the 1st aspect, the information acquisition unit acquires information over predetermined time intervals as long as a power ON state is sustained; and the metadata generation unit sequentially generates the metadata based upon latest information acquired via the information acquisition unit.

According to the 3rd aspect of the present invention, it is preferred that the image recording apparatus according to the 2nd aspect further comprises a decision-making unit that makes a decision as to whether or not a scene change has occurred based upon a predetermined condition, wherein the metadata generation unit sequentially generates the metadata based upon the latest information acquired via the information acquisition unit before an affirmative decision is made that a scene change has occurred.

According to the 4th aspect of the present invention, it is preferred that in the image recording apparatus according to the 3rd aspect, the image recording unit records a plurality of sets of the metadata in correlation to each of a plurality of the images, the plurality of sets of the metadata being sequentially generated before the affirmative scene change decision is made and the plurality of the images being obtained before the affirmative scene change decision is made.

According to the 5th aspect of the present invention, it is preferred that the image recording apparatus according to the 4th aspect further comprises: a metadata accumulating unit that accumulates the plurality of sets of the metadata sequentially generated before the affirmative scene change decision is made, wherein the information recording unit records the metadata accumulated in the metadata accumulating unit in correlation to each of the plurality of the images.

According to the 6th aspect of the present invention, a digital camera comprises: an imaging unit that generates a series of sets of image data; a recording control unit that records at least one set of the image data among the series of sets of the image data as imaging data; an information acquisition unit that acquires information related to at least one set of the image data among the series of sets of the image data; a metadata generation unit that generates metadata based upon the information acquired via the information acquisition unit; and an information recording unit that records the metadata in correlation to the imaging data, the metadata being generated at least after the imaging data are generated.

### BRIEF DESCRIPTION OF THE DRAWINGS

FIG. 1 is a block diagram showing the essential structural components of a digital camera;

FIG. 2 shows the structure of an Exif file;

FIG. 3 presents a flowchart of the photographing mode processing;

FIG. 4 presents a flowchart of the metadata recording processing;

FIG. 5 presents a flowchart of the scene change decision-making processing;

FIG. 6 presents a timing chart of an operation that may be executed when the main switch is in an ON state; and

FIG. 7 presents a flowchart of the reproduction processing.

### DESCRIPTION OF PREFERRED EMBODIMENT

The following is a description of an embodiment of the present invention, given in reference to the drawings. The digital camera achieved in the embodiment of the present invention may be switched to either a photographing mode or a reproduction mode. In the photographing mode, a subject image is captured and the data expressing the captured image is recorded as an image file into a recording medium constituted with a memory card or the like. The digital camera in the embodiment creates an image file that includes metadata constituted with information obtained before or after a photographing instruction is issued in addition to the image obtained in response to the photographing instruction. A detailed description of how such an image file is generated and recorded is provided later.

In the reproduction mode, the data in a specified image file are read out from, for instance, a recording medium and an image reproduced based upon the image data is brought up on display at an LCD panel. In the embodiment, the information included as metadata in the image file, too, is displayed as text superimposed over the reproduced image.

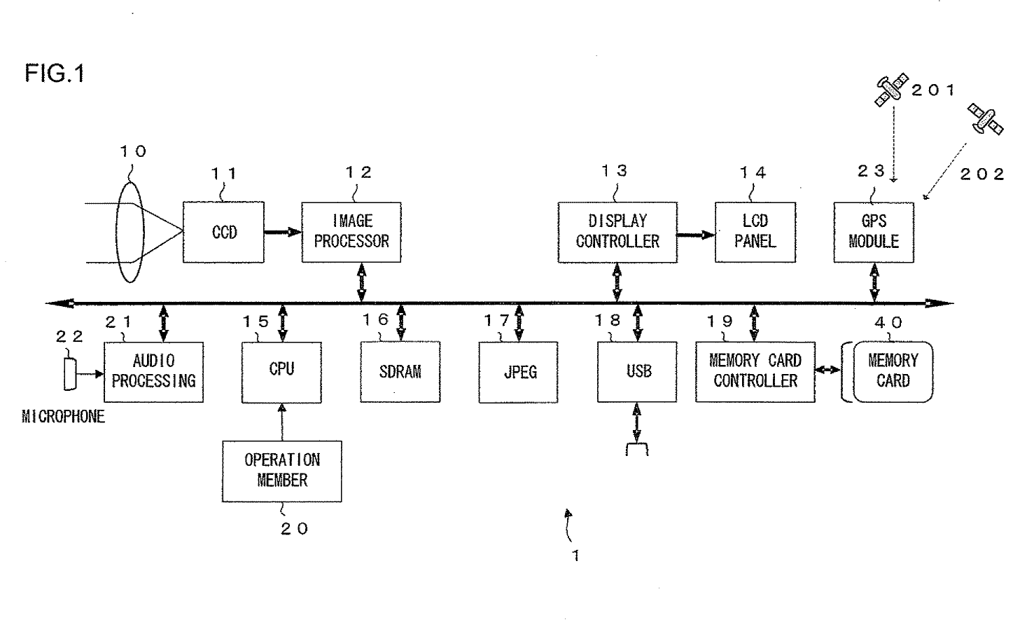

FIG. 1 is a block diagram showing the essential structural components constituting the digital camera 1. FIG. 1 shows a photographic lens 10, through which a subject image is formed at the imaging surface of an image sensor 11. The image sensor 11 may be constituted with a CCD image sensor or a CMOS image sensor. The image sensor 11 generates analog image signals through photoelectric conversion executed on the subject image.

The analog image signals are input to an image processing circuit 12. The image processing circuit 12 executes analog processing such as correlation double sampling, gain adjustment and the like on the analog image signals input thereto. The image signals having undergone the analog processing are converted to digital image data at an VD conversion circuit (not shown). In addition, the image processing circuit 12 executes specific image processing (color interpolation processing, gradation conversion processing, edge enhancement processing, white balance adjustment processing and the like) on the digital image data. The image data resulting from the image processing then undergo PEG compression processing at a compression/decompression circuit 17 and the compressed image data are recorded into an SDRAM 16. Data to undergo the image processing, data having undergone the image processing and data currently undergoing the image processing are temporarily recorded into the SDRAM 16.

A CPU 15 completes the photographing processing by reading out the JPEG compression code from the SDRAM 16 and recording the image data into a recording medium 40 as an image file (JPEG file) in which specific additional information (metadata) can be included. The recording medium 40 can be loaded into and unloaded from the digital camera 1 as necessary. The CPU 15 records data into the recording medium 40 and reads out data recorded in the recording medium 45 via a memory card controller 19.

In the reproduction mode, the CPU 15 reads out an image file containing a specific JPEG compression code recorded in the recording medium 40. It then engages the compression/decompression circuit 17 in decompression processing, also engages the image processing circuit 12 in resolution conversion to achieve the optimal size and temporarily records the resulting data into the SDRAM 16. In response to an instruction issued by the CPU 15, a display controller 13 reads out the image data from the SDRAM 16 and generates display data based upon the image data thus read out. At an LCD panel 14 disposed at the rear surface of the digital camera 1, an image reproduced based upon the display data and text information prepared based upon the metadata are brought up on display.

In the photographing mode, the CPU 15 engages the LCD panel 14 in operation as a viewfinder. The CPU 15 brings up on display at the LCD panel 14 a monitor image (live image) of the subject by engaging the display controller 13 in operation to generate display data based upon uncompressed digital image data. The term “live image” is used in this description to refer to the monitor image that is repeatedly obtained over predetermined time intervals (e.g., 30 frames per second) via the image sensor 11 before a photographing instruction is issued.

A USB controller 18 engages in specific communication with an external device (e.g., a PC). The digital camera 1 transfers an image file to the external device via the USB controller 18. The image file may be transferred for purposes of image file duplication or image file relocation.

The CPU 15 controls the operation of the digital camera 1 by executing a program stored in a built-in nonvolatile memory (not shown). The CPU 15 executes predetermined arithmetic operations by using signals input thereto from various blocks and outputs control signals generated based upon the arithmetic operation results to the individual blocks.

An operation member 20 includes a menu switch as well as a halfway press switch and a full press switch that are turned on/off by interlocking with a depression of a shutter release button (not shown). The operation member 20 outputs an operation signal corresponding to a specific operation to the CPU 15.

An audio processing circuit 21 amplifies audio signals generated by a microphone 22 and then converts the amplified signals to digital audio data via an A/D conversion circuit (not shown). The audio processing circuit 21 also executes specific signal processing on the digital audio data. Audio data resulting from the signal processing are recorded into the SDRAM 16.

Upon receiving radio waves transmitted from GPS satellites 201 and 202, a GPS module 23 obtains through calculation positioning information (indicating the latitude, longitude and altitude) by using information carried in received signals. It is to be noted that FIG. 1 only shows two satellites although the positioning operation is normally executed based upon information provided from four satellites. The CPU 15, which receives the positioning information from the GPS module 23 over predetermined time intervals, records the received positioning information into the SDRAM 16.

The embodiment is characterized in that a photographing time point at which an image in a photographic image to be included in an image file is captured and an information acquisition time point at which information to be written as metadata in the same image file is obtained do not match. The following explanation focuses on the processing executed to generate such an image file and the processing executed to generate the metadata.

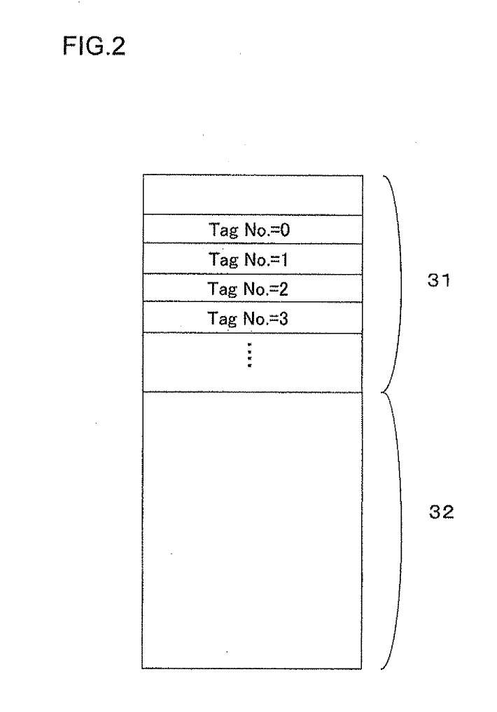

The CPU 15 generates an image file in the Exif format and records the image file thus generated into the recording medium 40. In the Exif image file, data expressing a thumbnail image, photographic information and the like are embedded in the image data in the JPEG format. As the file structure example presented in FIG. 2 indicates, the image file includes a tag area 31 where additional information pertaining to the image is recorded and an image data area 32 where the photographic image data are recorded. When a setting for saving metadata in relation to each photographic image is selected in the digital camera, the CPU 15 records metadata by reading the metadata saved in a specific area in the SDRAM 16 and recording the metadata thus read out into the tag area 31 of the image file.

(Metadata Generation)

Metadata are generated by repeatedly executing each of the following four types of processing individually over predetermined time intervals. A plurality of sets of metadata generated over the predetermined time intervals are individually recorded into specific areas in the SDRAM 16.

1) metadata generated through face detection processing
2) metadata generated through optical character recognition processing
3) metadata generated through voice recognition processing
4) metadata generated based upon operation information pertaining to operation executed at the digital camera 1

1) Metadata Generated Through Face Detection Processing

The digital camera 1 has a function of detecting a “face” contained in the live image explained earlier and determining whether or not the “face” belongs to a specified person. The digital camera 1 generates metadata based upon registered name information indicating the registered name (e.g., “Mr. Smith”) of the person with the recognized “face” among the “faces” contained in the live image. If no “face” is recognized, the digital camera 1 does not generate any metadata based upon the face detection processing results. Reference data used by the digital camera 1 when recognizing “faces” are recorded (registered) in advance in the built-in nonvolatile memory (not shown). The reference data may be registered through the following procedure.

The CPU 15 brings up on display at, for instance, the LCD panel 14 an “operation menu screen” (not shown) and executes registration photographing processing in response to an operation signal selecting a “registration photographing” option among the available menu options, with the operation signal being input from the operation member 20. The CPU 15 executes the registration photographing processing to record (register) into the non-volatile memory reference data constituted with characteristics quantity data indicating a “face” included in a captured image. In more specific terms, the CPU 15 generates thumbnail image data based upon the image data present over a predetermined range (e.g., a central area) of the photographic image and generates characteristics quantity data indicating a specific “face” based upon the image data. The CPU 15 then compiles reference data that include the characteristics quantity data and data indicating the registered name and records the reference data into the nonvolatile memory. The registered name is entered via the operation member 20. Through the procedure described above, reference data that enable identification of the particular person are registered.

2) Metadata Generated Through OCR Processing

The digital camera 1 generates metadata by using information indicating specific “characters” (e.g., “athletic meet”) contained in the live image. The CPU 15 identifies the characters by comparing them with patterns recorded in advance in the built-in nonvolatile memory (not shown) and generates metadata based upon the identified character information. If no “characters” are identified, the CPU 15 does not generate metadata based upon the OCR processing results.

3) Metadata Generated Through Voice Recognition Processing

The digital camera 1 generates metadata by using information indicating specific “words” (e.g., “welcome athletes”) picked up by the microphone 22. The CPU 15 executes voice recognition processing of the known art on audio signals obtained via the microphone 22 over a predetermined length of time (e.g., 5 seconds) having elapsed most recently among the audio signals generated by the microphone 22. The CPU 15 then is generates metadata by using information indicating the “words” recognized through the voice recognition processing. If no “words” are recognized, the CPU 15 does not generate any metadata based upon the voice recognition processing results.

4) Metadata Generated Based Upon Camera Operation Information

The digital camera 1 generates metadata based upon setting information. For instance, an operation signal indicating a “portrait photographing” mode may be input from the operation member 20 operated to select the particular photographing mode and, in such a case, metadata are generated by using the information indicating the “portrait photographing” mode. The operation signal may indicate a “macro photographing” mode, a “landscape photographing” mode or a “night scene photographing” mode or the like instead of the “portrait photographing” mode.

(Image File Generation Processing)

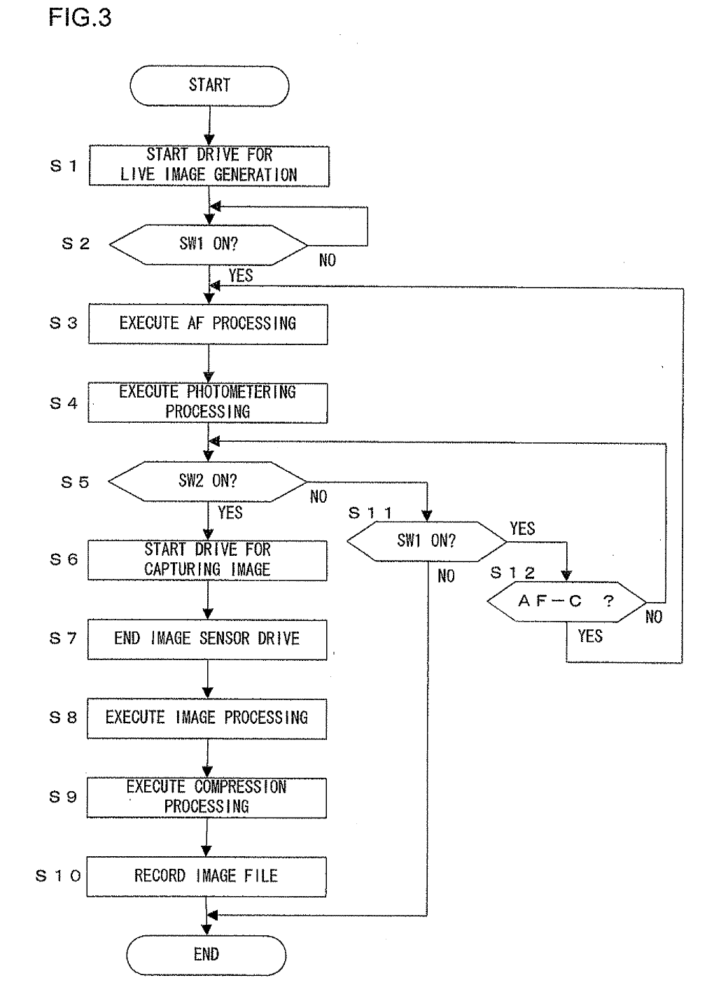

When a signal provided from the operation member 20 indicates a switchover to the photographing mode, the CPU 15 in the digital camera 1 switches to the photographing mode and repeatedly executes the image file generation processing, an example of which is presented in the flowchart in FIG. 3. FIG. 3 presents a flowchart of processing that may be executed by the CPU 15.

In step S1 in FIG. 3, the CPU 15 starts driving the image sensor 11 to obtain a live image and then the operation proceeds to step S2. In step S2, the CPU 15 makes a decision as to whether or not a halfway press switch SW1 has been turned on. The halfway press switch SW1, constituting part of the operation member 20, outputs an ON operation signal to the CPU 15 by interlocking with a depression of the shutter release button (not shown). The halfway press ON signal from the halfway press switch SW1 is output as the shutter release button is pressed down by an extent substantially equal to half the full stroke, and output of the halfway press ON signal stops as the depression of the shutter release button substantially to the halfway position ceases. If an ON operation signal has been input from the halfway press switch SW1, the CPU 15 makes an affirmative decision in step S2 in the operation proceeds to step S3. If, on the other hand, no ON operation signal has been input from the halfway press switch SW1, the CPU 15 makes a negative decision in step S2 and repeatedly executes the decision making processing.

In step S3, the CPU 15 executes AF (autofocus adjustment) processing before the operation proceeds to step S4. The AF processing may be executed by adopting, for instance, a contrast detection method whereby the focus match position for the focusing lens (not shown) is determined based upon contrast information obtained from the live image.

In step S4, the CPU 15 executes photometering processing before the operation proceeds to step S5. The photometering processing is executed to calculate a shutter speed and an aperture value based upon imaging signals obtained via the image sensor 11.

In step S5, the CPU 15 makes a decision as to whether or not a full press switch SW2 has been turned on. The full press switch SW2, constituting part of the operation member 20, outputs an ON operation signal to the CPU 15 by interlocking with a depression of the shutter release button (not shown). The full press ON signal from the full press switch SW2 is output as the shutter release button is pressed down by an extent substantially equal to the full stroke, and output of the full press ON signal is cleared as the depression of the shutter release button all the way down ceases. If an ON operation signal has been input from the full press switch SW2, the CPU 15 makes an affirmative decision in step S5 and the operation proceeds to execute photographing processing in step S6 and subsequent steps. If, on the other hand, no ON operation signal has been input from the full press switch SW2, the CPU 15 makes a negative decision in step S5 and the operation proceeds to step S11.

In step S11, the CPU 15 makes a decision as to whether or not the halfway press switch SW1 is in an ON state. If an ON operation signal has been continuously input from the halfway press switch SW1, the CPU 15 makes an affirmative decision in step S11 and the operation proceeds to step S12. If no ON operation signal has been input from the halfway press switch SW1, however, the CPU 15 makes a negative decision in step S11 and ends the processing in FIG. 3.

In step S12, the CPU 15 makes a decision with regard to AF servo setting details. If an AF-C mode has been set as the AF servo, the CPU 15 makes an affirmative decision in step S12 and the operation returns to step S3. The AF-C mode is selected to repeatedly execute the focus adjustment processing. If, on the other hand, an AF-S mode has been selected as the AF servo, the CPU 15 makes a negative decision in step S12 and the operation returns to step S5. The AF-S mode is selected in order to execute the focus adjustment processing once and hold the focusing condition having been achieved through the focus adjustment processing (AF lock). A specific AF servo is selected by the user in advance by operating a setting operation member 20.

In step S6, to which the operation proceeds after making an affirmative decision in step S5, the CPU 15 initializes (e.g., wipes residual electrical charges) the image sensor 11 and starts drive of the image sensor for exposure and electrical charge storage in order to obtain a photographic image, before the operation proceeds to step S7. Once the electrical charges have been stored over a length of time corresponding to the shutter speed, the CPU 15 ends the drive for electrical charge storage in step S7, and then the operation proceeds to step S8.

In step S8, the CPU 15 executes the specific image processing on image signals output from the image sensor 11, and then the operation proceeds to step S9. In step S9, the CPU 15 executes the specific compression processing on the image signals having undergone the image processing, before the operation proceeds to step S10.

In step S10, the CPU 15 generates an image file in the Exif format described earlier and records the image file into the recording medium 40 before ending the processing in FIG. 3. The CPU 15 achieved in the embodiment records the image file in correspondence to a specific scene number. The concept of scene numbers is to be described in detail later. Through the metadata recording processing to be described later, metadata are recorded into the tag area of the image file.

(Metadata Recording Processing)

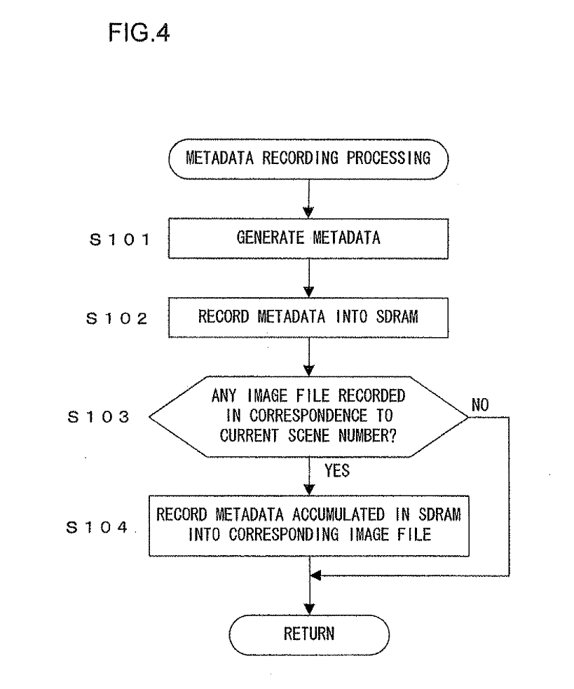

The flow of the metadata recording processing is now described in reference to the flowchart presented in FIG. 4. The CPU 15 executes the processing shown in FIG. 4 as interrupt processing over predetermined time intervals while the main switch at the digital camera 1 remains in the ON state. In step S101 in FIG. 4, the CPU 15 executes the metadata generation processing described earlier and then the operation proceeds to step S102.

In step S102, the CPU 15 records the metadata having been generated into a specific area (metadata buffer) in the SDRAM 16, and then the operation proceeds to step S103. In step S103, the CPU 15 makes a decision as to whether or not there is an image file having been recorded in correspondence to the current scene number. If an image file corresponding to the current scene number exists in the recording medium 40, the CPU 15 makes an affirmative decision in step S103 and the operation proceeds to step S104. If, on the other hand, no image file corresponding to the current scene number exists within the recording medium 40, the CPU 15 makes a negative decision in step S103 and ends the processing in FIG. 4. The concept of scene numbers is to be described in detail later.

In step S104, the CPU 15 individually records metadata that have accumulated in the metadata buffer (SDRAM 16) into the tag area of each image file recorded in the recording medium 40 in correspondence to the current scene number. It is to be noted that the CPU 15 simply records part of the metadata stored in the metadata buffer that has not been already recorded in the tag area of the given image file. Through this metadata recording processing, common metadata are recorded into all the image files recorded in correspondence to the current scene number.

(Scene Change Decision-Making Processing)

The concept of “scene numbers” mentioned earlier is now explained. The CPU 15 achieved in the embodiment records image files each in correspondence to a specific scene number. Upon judging that predetermined scene change conditions are satisfied, the CPU 15 increments the scene number. Accordingly, if the photographing processing is executed a plurality of times before the scene number changes, the CPU 15 records a plurality of image files in correspondence to the same scene number.

The CPU 15 makes a decision as to whether or not the scene change conditions are satisfied by individually checking the following four conditions.

1) length of time having elapsed
2) distance by which the photographing location has moved
3) length of time over which a low brightness level is maintained
4) volume of sound picked up by microphone

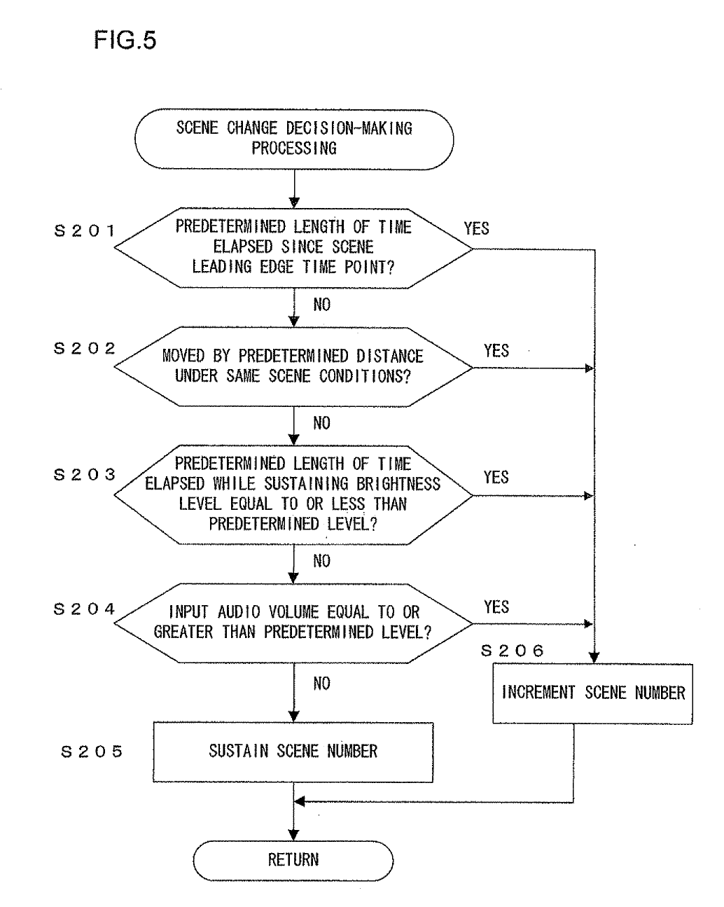

FIG. 5 presents a flowchart of the scene change decision-making processing. The CPU 15 executes the processing shown in FIG. 5 as interrupt processing over predetermined time intervals while the main switch remains in the ON state. In step S201 in FIG. 5, the CPU 15 makes a decision as to whether or not a predetermined length of time has elapsed following a scene leading edge time point. The CPU 15 makes an affirmative decision in step S201 if, for instance, four hours have elapsed since the time point at which the scene number was most recently incremented and the operation proceeds to step S206 in this case. However, the CPU 15 makes a negative decision in step S201 if four hours have not elapsed since the previous scene number increment time point and the operation then proceeds to step S202.

In step S202, the CPU makes a decision as to whether or not a displacement by a predetermined distance has occurred while holding the current scene number. The CPU 15 calculates the distance by which the digital camera 1 has moved based upon the positioning information and if the digital camera has moved by, for instance, 10 km since the most recent scene number increment time point, it makes an affirmative decision in step S202 to allow the operation to proceed to step S206. If, on the other hand, the is digital camera 1 has moved by less than 10 km since the previous scene number increment time point, the CPU 15 makes a negative decision in step S202 and the operation proceeds to step S203.

In step S203, the CPU 15 makes a decision as to whether or not a state in which the brightness is at or lower than a predetermined level has been sustained over a predetermined length of time. The CPU 15 makes an affirmative decision in step S204 if a state in which the brightness, indicated in brightness information obtained based upon the imaging signal level, is equal to or less than a predetermined value has been held for, for instance, at least 10 seconds, and the operation proceeds to step S206 in such a case. The CPU 15, however, makes a negative decision in step S203 if the brightness information indicates a brightness level equal to or greater than the predetermined value or the state in which the brightness indicated in the brightness information is equal to or less than the predetermined value has been sustained for less than 10 seconds, and the operation then proceeds to step S204.

In step S204, the CPU 15 makes a decision as to whether or not the input audio volume is equal to or greater than a predetermined level. The CPU 15 makes an affirmative decision in step S204 if input audio volume information, obtained based upon the audio signal level, indicates a value equal to or greater than a predetermined value, and the operation proceeds to step S206 in this case. The CPU 15, however, makes a negative decision in step S204 if the input audio volume information indicates a value less than the predetermined value and the operation proceeds to step S205 in this case.

The operation proceeds to step S205 when the CPU determines that the scene has not changed. In step S205, the CPU 15 holds over the current scene number before ending the processing in FIG. 5.

The operation proceeds to step S206 when the CPU determines that the scene has changed. The CPU 15 increments the current scene number before ending the processing in FIG. 5. It is to be noted that the CPU 15 records into the metadata buffer information indicating the step number assigned to the step in which an affirmative decision has been made among steps S201 through S204 and time point information indicating the time point at which the scene number has been incremented.

(Example of Timing)

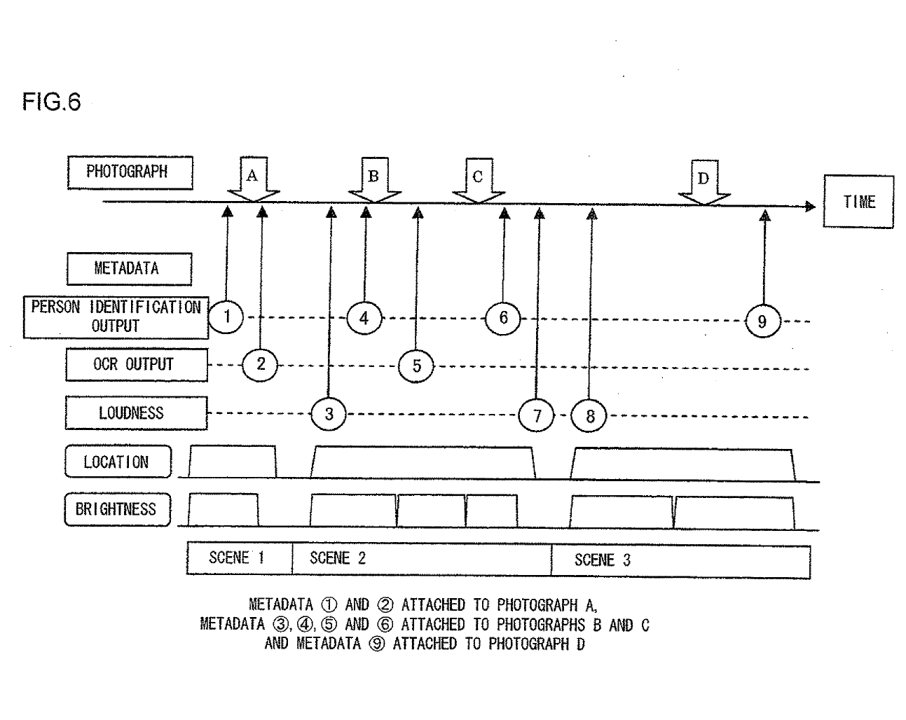

FIG. 6 presents a timing chart of an operation that may be executed in the digital camera 1 while the main switch remains in the ON state. “Photograph” in FIG. 6 indicates the timing with which a photographing instruction (Rill press switch SW2 ON) is issued. In the embodiment, a photographing instruction is issued four times at “A”, “B”, “C” and “D” and photographing processing is executed in response to each photographing instruction.

“Person identification output” indicates the timing with which the CPU 15 detects a “face” contained in the live image and identifies the “face” as the “face” of a specific person. The CPU 15 in the embodiment sequentially executes “face” detection based upon the live image and identifies persons whose “faces” have been detected at four times at time points “1”, “4”, “6” and “9”. In the example, a single person “Mr. Jones” is identified based upon the faces detected at the four time points.

“OCR output” indicates the timing with which the CPU 15 identifies “characters” contained in the live image. The CPU 15 in the embodiment sequentially executes OCR processing based upon the live image and identifies “characters” twice at time points “2” and “5”. In the example presented in the figure, the characters “athletic meet” are identified with the timing “2” and the characters “grade 3” are identified with the timing “5”.

“Loudness” indicates the timing with which the volume of the input audio is equal to or greater than a predetermined level. In the embodiment, an audio signal assuming a level equal to or greater than the predetermined level is input 3 times at time points “3”, “7” and “8”. It is assumed that “public address announcement” is made with the timing “3”, “drums” roll with the timing “7” and “roars” are heard with the timing “8”.

“Location” indicates the communication condition with which radio waves from the GPS satellites 201 and 202 are received at the GPS module 23, with H level indicating the communication-on state (positioning information is obtained) and L level indicating the communication-off state.

“Brightness” indicates the brightness information obtained based upon the imaging signal level, with H level equivalent to a brightness level equal to or greater than the predetermined value and L level equivalent to a brightness level less than the predetermined value. The CPU 15 in the embodiment twice determines that the scene has changed based upon the level indicated in the brightness information and increments the scene number “1” to “2” and then the scene number “2” to “3” based upon the two sets of scene change decision-making results.

The photographing instruction timing “A”, the person identification timing “1” and the OCR output timing “2” all correspond to scene number 1. Namely, the CPU records metadata indicating “Mr. Jones”, having been generated prior to the photographing instruction timing “A” and metadata indicating “athletic meet”, generated after the photographing instruction timing “A”, into an image file generated by capturing an image with the photographing instruction timing “A”.

The photographing instruction timing “B” and “C”, the person identification timing “4” and “6”, the OCR output timing “5” and the loudness timing “3” and “7” all correspond to scene number 2. Two image files, i.e., an image file generated by capturing an image with the photographing instruction timing “B” and an image file generated by capturing an image with the photographing instruction timing “C”, are generated in correspondence to scene number 2. The CPU 15 records identical metadata into these two image files. Namely, the CPU 15 records metadata indicating “Mr. Jones” and metadata indicating “public address announcement”, both having been generated prior to the photographing instruction timing “B” and metadata indicating “grade 3” and metadata indicating “Mr. Jones” generated following the photographing instruction timing “B”. It is to be noted that while the “drums” roll with the timing “7”, the CPU 15, the sound of drums does not contain any words and so the CPU 15 does not generate any metadata based upon the audio processing results.

The photographing instruction timing “D”, the person identification timing “9” and the loudness timing “8” all correspond to scene number 3. The CPU 15 records metadata indicating “Mr. Jones” generated after the photographing instruction timing “D” into an image file generated by capturing an image with the photographing instruction timing “D”. It is to be noted that while the “roars” with the timing “8”, the sound of roars does not contain any words and so the CPU 15 does not generate any metadata based upon the audio processing results.

(Image File Reproduction Processing)

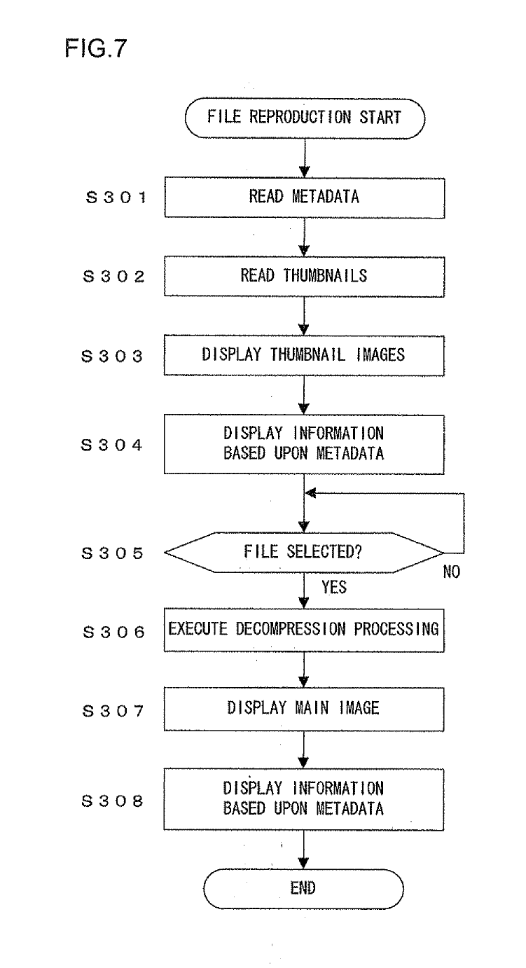

As an instruction for a switchover to the reproduction mode is issued via an operation signal output from the operation member 20, the CPU 15 in the digital camera 1 switches to the reproduction mode and repeatedly executes the image file reproduction processing, an example of which is presented in FIG. 7. FIG. 7 presents a flowchart of processing that may be executed by the CPU 15.

In step S301 in FIG. 7, the CPU 15 reads the metadata in the various image files recorded in the recording medium 40 and then the operation proceeds to step S302. In step S302, the CPU 15 reads the thumbnail image data in the image files recorded in the recording medium 40 before the operation proceeds to step S303.

In step S303, the CPU 15 brings up a side-by-side display (at-a-glance display) of images reproduced based upon the thumbnail image data at the LCD panel 14 and then the operation proceeds to step S304. In step S304, the CPU 15 superimposes text generated based upon metadata over the thumbnail images and then the operation proceeds to step S305. If a plurality of sets of metadata are available in correspondence to a single thumbnail image, a single set of representative metadata (e.g., “Mr. Jones” generated based upon the face detection processing results) should be displayed.

In step S305, the CPU 15 makes a decision as to whether or not a specific image file to be reproduced and displayed has been indicated. The CPU 15, having received an image file selection instruction in the form of an operation signal output from the operation member 20, makes an affirmative decision in step S305 and the operation proceeds to step S306 in such a case. However, if no image file selection instruction has been received, the CPU 15 makes a negative decision in step S305 and repeatedly executes the decision-making processing.

In step S306, the CPU 15 reads out the selected image file from the recording medium 40 and executes decompression processing to decompress the data based upon the JPEG compression code before the operation proceeds to step S307. As a result, the main photographic image in the image file becomes decompressed.

In step S307, the CPU 15 brings up on display at the LCD panel 14 an image reproduced based upon the main image data having undergone the decompression processing and then the operation proceeds to step S308. In step S308, the CPU 15 displays text generated based upon the metadata by superimposing it over the thumbnail image, before ending the processing in FIG. 7. If a plurality of sets of metadata are available in correspondence to the particular main photographic image, the CPU 15 displays the text generated based upon all the metadata (e.g., “Mr. Jones” generated based upon the face detection processing results and “athletic meet” generated based upon the OCR processing results).

The following advantages are achieved through the embodiment described above,

(1) In correspondence to an image to be recorded in the recording medium 40, the CPU 15 in the digital camera 1 obtains information based upon face detection processing results, optical character recognition processing results and voice recognition processing results as well as operation information pertaining to the operation of the digital camera 1 at least after the time point at which the image to be recorded is obtained. The CPU 15 then generates metadata based upon the information thus obtained and records the generated metadata and the image into the recording medium 40 by correlating them to each other. Through this process, information is recorded to provide useful clues that will help the viewer looking at the particular image determine the circumstances under which the photograph was taken.

(2) The CPU 15 obtains information over predetermined time intervals as long as power to the digital camera is on and sequentially generates metadata based upon the most recently obtained information. Thus, more recent information, obtained after capturing the image to be recorded, can be included in the metadata.

(3) The CPU 15 determines that the scene has changed based upon specific conditions and sequentially generates metadata based upon the most recent information obtained until the next scene change. As a result, recent information obtained after capturing the image to be recorded prior to the next scene change can be included in the metadata.

(4) The CPU 15 records a plurality of sets of metadata sequentially generated before it makes the next affirmative scene change decision by correlating them with each of a plurality of images obtained prior to the next scene change. Thus, a plurality of sets of common metadata can be recorded in correspondence to each of the plurality of images captured between scene changes.

(5) The CPU 15 accumulates in the metadata buffer (within the SDRAM 16) the plurality of sets of metadata sequentially generated before it makes the next affirmative scene change decision and records the metadata accumulated in the metadata buffer by correlating them with each of a plurality of images. This means that the metadata can be saved with a high level of reliability even when a scene change does not occur over an extended period of time.

(Variation 1)

The CPU 15 may generate a metadata file for metadata storage and may record the metadata file in the recording medium 40. In such a case, the CPU 15 will store in the metadata file all the metadata having been generated in correspondence to each scene number. The CPU 15 may include in the metadata file information indicating the leading edge time point of each scene (the time point at which the scene number is incremented) and information indicating the cause for ending each scene (the main factor in making an affirmative scene change decision resulting in an increment of the scene number).

(Variation 2)

The CPU 15 may record in the recording medium 40 a photo list file listing the photographic images corresponding to each scene number. In such a case, the CPU 15 may store in the photo list file the thumbnail image data in all the image files having been correlated to each scene number.

The above described embodiment is an example and various modifications can be made without departing from the scope of the invention.

What is claimed is:

1. An image recording apparatus, comprising:
an information acquisition unit;
a metadata generation unit that generates metadata based upon acquired information, the metadata being different from an image to be recorded and the acquired information being obtained by the information acquisition unit at least after the image is obtained; and
an information recording unit that records the metadata having been generated and the image in correlation to each other.

2. An image recording apparatus according to claim 1, wherein:
the information acquisition unit acquires information over predetermined time intervals as long as a power ON state is sustained; and
the metadata generation unit sequentially generates the metadata based upon latest information acquired via the information acquisition unit.

3. An image recording apparatus according to claim 2, further comprising:
a decision-making unit that makes a decision as to whether or not a scene change has occurred based upon a predetermined condition, wherein:
the metadata generation unit sequentially generates the metadata based upon the latest information acquired via the information acquisition unit before an affirmative decision is made that a scene change has occurred.

4. An image recording apparatus according to claim 3, wherein:
the image recording unit records a plurality of sets of the metadata in correlation to each of a plurality of the images, the plurality of sets of the metadata being sequentially generated before the affirmative scene change decision is made and the plurality of the images being obtained before the affirmative scene change decision is made.

5. An image recording apparatus according to claim 4, further comprising:
a metadata accumulating unit that accumulates the plurality of sets of the metadata sequentially generated before the affirmative scene change decision is made, wherein:
the information recording unit records the metadata accumulated in the metadata accumulating unit in correlation to each of the plurality of the images.

6. A digital camera, comprising:
an imaging unit that generates a series of sets of image data;
a recording control unit that records at least one set of the image data among the series of sets of the image data as imaging data;
an information acquisition unit that acquires information related to at least one set of the image data among the series of sets of the image data;
a metadata generation unit that generates metadata based upon the information acquired via the information acquisition unit; and
an information recording unit that records the metadata in correlation to the imaging data, the metadata being generated at least after the imaging data are generated.
